(19) United States
(12) Patent Application Publication
(10) Pub. No.: US 2026/0299861 A1
(43) Pub. Date: Oct. 1, 2026

(54) DISPLAY METHOD AND DEVICE

(71) Applicant: Lenovo (Beijing) Limited, Beijing (CN)

(72) Inventor: Liang ZHANG, Beijing (CN)

(21) Appl. No.: 19/630,486

(22) Filed: Mar. 27, 2026

(30) Foreign Application Priority Data
Mar. 31, 2025 (CN) 202510400221.6

(51) Int. Cl. G06F 3/14; G06T 11/60

(52) U.S. Cl. CPC G06F 3/1407; G06F 3/1415; G06T 11/60

(57) ABSTRACT

A display method includes displaying a target image sequence in response to an interactive operation instructing to input target input data into a target intelligent engine for image data generation, and displaying target image data in response to the target intelligent engine generating the target image data. The target image sequence includes at least a first image and a second image, and at least one of the first image or the second image has a correlation with the target input data.

### CROSS-REFERENCE TO RELATED APPLICATION

This application claims priority to Chinese Patent Application No. 202510400221.6, filed on Mar. 31, 2025, the entire content of which is incorporated herein by reference.

### TECHNICAL FIELD

The present disclosure generally relates to the field of display technology and, more particularly, to a display method and device.

### BACKGROUND

Images can be generated from input data. However, the image generation process usually takes some time. During this waiting period, the current display method relies on traditional loading animations, such as progress bars or flashing icons. Although these animations can indicate that an image is being generated, they have no direct connection to the input data, resulting in relatively poor user experience with the current display method.

### SUMMARY

In accordance with the present disclosure, there is provided a display method including displaying a target image sequence in response to an interactive operation instructing to input target input data into a target intelligent engine to for image data generation, and displaying target image data in response to the target intelligent engine generating the target image data. The target image sequence includes at least a first image and a second image, and at least one of the first image or the second image has a correlation with the target input data.

Also in accordance with the present disclosure, there is provided an electronic device including a processor, and a memory storing an application program that, when executed by the processor, causes the electronic device to display a target image sequence in response to an interactive operation instructing to input target input data into a target intelligent engine for image data generation, and display target image data in response to the target intelligent engine generating the target image data. The target image sequence includes at least a first image and a second image, and at least one of the first image or the second image has a correlation with the target input data.

Also in accordance with the present disclosure, there is provided a non-transitory computer-readable storage medium storing an application program that, when executed by a processor, causes an electronic device including the processor to display a target image sequence in response to an interactive operation instructing to input target input data into a target intelligent engine for image data generation, and display target image data in response to the target intelligent engine generating the target image data. The target image sequence includes at least a first image and a second image, and at least one of the first image or the second image has a correlation with the target input data.

### BRIEF DESCRIPTION OF THE DRAWINGS

The above and other objects, features, and advantages of the embodiments of the present disclosure will become readily understood by reading the following detailed description with reference to the accompanying drawings. The accompanying drawings illustrate several embodiments of the present disclosure by way of example and not limitation.

In the drawings, the same or corresponding reference numerals denote the same or corresponding parts.

FIG. 1 is a schematic flowchart of the display method consistent with the present disclosure.

FIG. 2 is another schematic flowchart of the display method consistent with the present disclosure.

FIG. 3 is another schematic flowchart of the display method consistent with the present disclosure.

FIG. 4 shows an application scenario of the display method consistent with the present disclosure.

FIG. 5 is a schematic diagram of a display apparatus consistent with the present disclosure.

### DETAILED DESCRIPTION OF THE EMBODIMENTS

To make the objectives, technical solutions, and advantages of the embodiments of the present disclosure clearer, the technical solutions of the present disclosure will be described below with reference to the accompanying drawings. Obviously, the described embodiments are only some embodiments of the present disclosure, not all embodiments. All other embodiments obtained by those skilled in the art based on the described embodiments without creative effort are within the scope of the present disclosure.

In the following description, the term “some embodiments” refers to a subset of all possible embodiments. However, “some embodiments” can be the same subset or different subsets of all possible embodiments, and can be combined with each other without conflict. In the following description, the terms associated with “first” and “second” are used merely to distinguish similar objects and do not represent a specific ordering of objects. It is understood that “first” and “second” can be interchanged in a specific order or sequence where permissible, so that the embodiments of the present disclosure described herein can be implemented in an order other than that illustrated or described herein.

Unless otherwise defined, all technical and scientific terms used herein have the same meaning as commonly understood by one of ordinary skill in the art to which the present disclosure belongs. The terminology used herein is for the purpose of describing embodiments of the present disclosure only and is not intended to limit the present disclosure.

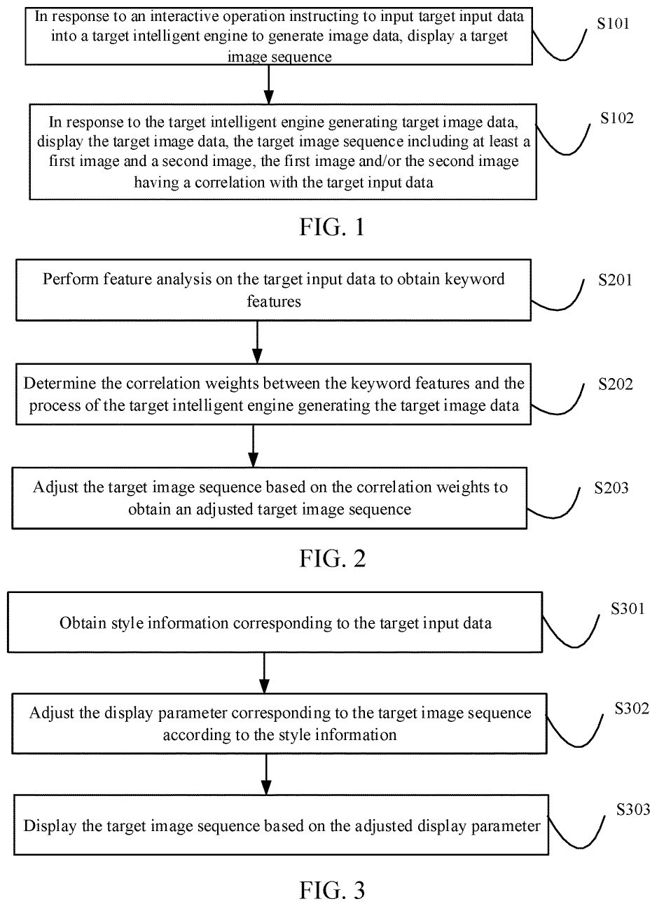

The flowchart of the display method of the present disclosure will be described in FIG. 1 in conjunction with S101-S102.

At S101, in response to an interactive operation instructing to input target input data into a target intelligent engine to generate image data, a target image sequence is displayed.

In some embodiments, the target input data may include data input by the user to prompt the target intelligent engine to generate images. The target input data may specifically include input data such as text data, image data, and audio data, and may contain only one type of data or multiple types of data. The present disclosure does not limit the specific input data. The target intelligent engine may include a model that processes target input data and generates image data based on artificial intelligence technology. The present disclosure does not limit the specific model. Interactive operation may include that user interacts with the target intelligent engine through set instructions. Specific interactive operation may include instructions for inputting text data, inputting image data, and inputting audio data, etc. The present disclosure does not limit the specific interactive operation. The target image sequence may include a series of images displayed during the process of the target intelligent engine generating target image data.

The target intelligent engine may be a target model with more than one hundred million weight parameters. The target model learns the features and patterns of input information by training on a large amount of diverse data. Model typically has hundreds of millions to hundreds of billions of model parameters (model parameters are variables that control the behavior of the target model), and captures complex relationships and patterns in the input information. The target input data can guide the target model to perform inference. In some embodiments, the target model may be a generative model. For example, the target model may specifically include a large visual model, a large multimodal model, etc. The model in the embodiments of the present disclosure can be general large model or expert large model obtained by fine-tuning based on needs. The embodiments of the present disclosure do not limit this.

At S102, in response to the target intelligent engine generating target image data, the target image data is displayed, the target image sequence including at least a first image and a second image, the first image and/or the second image having a correlation with the target input data.

In some embodiments, the target image data may include image data ultimately generated by the target intelligent engine. The first image may include any image in the target image sequence. The first image may have a correlation with the target input data. The second image may include a subsequent image of the first image in the target image sequence. The second image may have a correlation with the target input data. One of the first image and the second image may have a correlation with the target input data. The target image sequence may be a continuous animation composed of the first image and the second image, and the continuous animation has a correlation with the target input data. When the target intelligent engine generates the target image data, the target image sequence is hidden and the target image data is displayed.

The method consistent with the present disclosure, by displaying a dynamically changing target image sequence related to the input data during the image generation waiting period, makes the waiting animation semantically more consistent with the process of generating target image data, enhancing the user's intuitive perception of the device's image data generation process and improving the user experience.

In some embodiments, the display method further includes: if the target input data is first input data, the target image sequence is a first image sequence; if the target input data is second input data, the target image sequence is a second image sequence.

For example, the first input data and the second input data are different input data. Specifically, the first input data and the second input data may differ in data type, format, and semantics. For example, the first input data may be input text data, while the second input data may be input image data. The first input data and the second input data may also be of the same data type but different in content. For example, the first input data may be a piece of text data describing the generation of a building landscape image, while the second input data may be a piece of text data describing the generation of a car image; both are text data but different in content. Correspondingly, the first image sequence and the second image sequence are different image sequences; the first image sequence may be associated with the first input data, and the second image sequence may be associated with the second input data. The first image sequence can specifically be a continuous animation composed of a series of images associated with the first input data. The second image sequence can specifically be a continuous animation composed of a series of images associated with the second input data. The corresponding displayed image sequences will also differ depending on the input data.

The method of the present disclosure, by displaying a dynamically changing target image sequence associated with the input data during the image generation waiting period, makes the waiting animation semantically more consistent with the process of generating the target image data. By displaying different image sequences according to different input data, it enhances the user's intuitive perception of the device's image data generation process and improves the user experience.

In some embodiments, the first image and/or the second image includes first image content and second image content; the first image content has a first correlation with the target input data, and the second image content has a second correlation with the target image data.

For example, the first image may include first image content, and the second image may include second image content. Displaying the target image sequence may include displaying the first image and the second image sequentially. For example, at a first moment, the first image content having a first correlation with the target input data is displayed, and at a second moment, the second image content having a second correlation with the target image data is displayed. The target image sequence can represent the process of target input data changing into target image data; specifically, the first image content related to the target input data may gradually decrease, while the second image content related to the generated target image data may gradually increase.

For example, the first image may include both first image content and second image content. The second image may include both first image content and second image content. The target input data includes the input “Generate a brightly lit city, including skyscrapers and roads.” To display the target image sequence, firstly, the first image is displayed and simultaneously includes both first image content and second image content. The first image content is a simple text graphic of “skyscrapers” and “roads,” having a first correlation with the target input data; the second image content can be the lighting effects of skyscrapers and roads, having a second correlation with the target image data. Then, the second image is displayed and simultaneously includes both first image content and second image content. In the second image, the content of the first image gradually decreases; for example, the outlines of simple text graphic begin to fade, while the content of the second image gradually increases; for example, the lighting effects of tall buildings and the trajectory images of roads become more prominent.

The method of the present disclosure, by displaying a dynamically changing target image sequence related to the input data and the final generated image during the image generation waiting period, makes the waiting animation semantically more consistent with the process of generating target image data, enhancing the user's intuitive perception of the device's image data generation process and improving the user experience.

In some embodiments, the first image and/or the second image includes target image content representing the target input data; the target image content includes a first image parameter in the first image and a second image parameter in the second image, the first image parameter being different from the second image parameter.

For example, the target image content may include content related to the target input data. The target image content may be information extracted from the input data. The first image parameter can be configured to control the gradient display visual effect of the target image content displayed in the first image, and the second image parameter can be configured to control the gradient display visual effect of the target image content displayed in the second image. The gradient display visual effect may include size gradient display, hue gradient display, transparency gradient display, and rotation angle gradient display. The image parameter of the target image content may include at least one of the following: the position within the image, area occupied within the image, color tone within the image, transparency within the image, and rotation angle within the image.

The method of the present disclosure, by displaying a dynamically changing target image sequence related to the input data during the image generation waiting period, makes the waiting animation semantically more consistent with the process of generating the target image data. By adjusting the image parameter of the target image content, the dynamic changes of the image sequence are achieved, allowing the user to experience the image generation process during the waiting period, enhancing the user's intuitive perception of the device's image data generation process, and improving the user experience.

In some embodiments, the target input data includes text data; the target image content includes one or more character graphics representing text data.

For example, the target input data includes the text data “Generate a tranquil lake, surrounded by mountains.” Displaying the target image sequence begins with displaying a first image, the first image includes the target image content. The target image content includes text characters for “lake,” “tranquil,” “surrounded,” and “mountains.” The first image parameter corresponding to the text characters for “lake” in the target image content in the first image include a light blue hue, 100% transparency, and a rotation angle of 0 degrees. Then, a second image is displayed, containing the target image content. The target image content includes text characters for “lake,” “tranquil,” “surrounded,” and “mountains.” The text characters for “lake” in the target image content corresponds to the following second image parameter in the second image: a dark blue hue, 80% transparency, and a 5-degree rotation angle.

In some embodiments, the one or more character graphics have a first degree of display disorder in the first image; the one or more character graphics have a second degree of display disorder in the second image.

For example, display disorder can represent a process where text characters changes from neatly arranged to scattered and randomly moved. First, the first image is displayed, containing the text characters for “lake,” “tranquil,” “surrounded,” and “mountains.” In the first image, the text characters has a low degree of display disorder; the text is neatly arranged, with uniform letter spacing, all text characters is uniformly light blue, has 100% transparency, no rotation angle, and an overall well-organized layout with concentrated text content. Then, the second image is displayed, containing the text characters for “lake,” “tranquil,” “surrounded,” and “mountains.” However, in this second image, the text characters has a higher degree of display disorder. The text characters exhibits a scattered arrangement, irregular character spacing, a dark blue color change in some text characters, reduced transparency to 80%, and a 5-degree rotation angle for each character. The overall layout of the text data is scattered and disordered, and the display position of the text characters in the second image changes randomly.

The method consistent with the present disclosure displays a dynamically changing target image sequence related to the input text data during the image generation waiting period. This makes the waiting animation semantically more consistent with the process of generating the target image data, transforming text content into visual elements. By changing the display disorder of the text data, the image generation process is displayed intuitively, allowing the user to experience the image generation process during the waiting period. This enhances the user's intuitive perception of the device's image data generation process and improves the user experience.

In some embodiments, the first image is the image data output by the target intelligent engine in the first stage; the second image is the image data output by the target intelligent engine in the second stage; and the target image data is the final image data output by the target intelligent engine.

For example, the target input data includes the input “Generate an image of a kitten.” A target image sequence is displayed, including the first image and the second image. The first image displayed first is the image data output by the target intelligent engine in the first stage. For example, the first image is a preliminary outline image from the target AI engine based on the target input data. This first image might include a simple kitten outline, featuring a basic head, ears, eyes, and whiskers. The colors and details are relatively simple; for example, the kitten might be a single shade of beige, and the eyes might be small black dots. The second image displayed is the image data output by the target AI engine in the second stage. For example, the second image is generated by the target AI engine based on the target input data and the preliminary outline image. Compared to the first image, the second image has more added details, such as the kitten's fur texture, the highlight effect in the eyes, the specific details of the whiskers, and a simpler background rendering, such as adding a blurred indoor environment. The target AI engine continues processing and finally outputs the target image data. In response to the target AI engine outputting the target image data, the target image sequence is hidden, and the target image data is displayed. The target image data includes richer details, such as the delicate texture of the kitten's fur, the bright expression in the eyes, the natural curve of the whiskers, and a clearer background, such as the addition of furniture and toys. The overall colors are softer and have corresponding lighting effects.

The method consistent with the present disclosure displays a target image sequence related to the input data during the image generation waiting period, making the waiting animation semantically more consistent with the process of generating the target image data. By outputting image data in stages, the gradual improvement process of image generation is demonstrated, achieving dynamic changes in the image sequence. This allows the user to experience the image generation process during the waiting period, enhancing the user's intuitive perception of the device's image data generation process and improving the user experience.

In some embodiments, a flowchart of the display method is shown in FIG. 2. As shown in FIG. 2, the method further include the following.

At S201, feature analysis is performed on the target input data to obtain keyword features.

At S202, the correlation weights between the keyword features and the process of the target intelligent engine generating the target image data is determined.

At S203, the target image sequence is adjusted based on the correlation weights to obtain an adjusted target image sequence.

In some embodiments, feature analysis may include analyzing the target input data and extracting key features therein. Keyword features may include key information extracted from the target input data. The correlation weights can include a measure of the correlation between keyword features and the process by which the target intelligent engine generates target image data. Specifically, the correlation weights represent the importance of keyword features in the process of generating target image data. Adjusting the target image sequence can include adjusting the image content within the target image sequence.

For example, the target input data includes the text data “Generate an image of a cute kitten.” Feature analysis of the target input data yields keyword features that may include “generate,” “an,” “cute,” “kitten,” and “image.” Determining the correlation weights between the keyword features and the process by which the target intelligent engine generates target image data includes: determining a correlation weight of 0.3 to “generate,” 0.5 to “an,” 0.9 to “cute,”0.9 to “kitten,” and 0.6 to “image.” The target image sequence is then adjusted based on these correlation weights. For example, the keywords “kitten” and “cute” have high correlation weights. Adjusting the image content related to “kitten” and “cute” in the target image sequence to display these images more prominently. Specifically, displaying these images more prominently includes adjusting the image parameter of the image content corresponding to “kitten” and “cute,” such as adjusting the color tone of the image content corresponding to “kitten” and “cute” to a more vibrant tone or centering the position of the image content corresponding to “kitten” and “cute.” The present disclosure does not limit the specific method of adjusting image parameter. Then, the adjusted target image sequence is displayed.

The method of the present disclosure, by displaying a target image sequence related to the input data during the image generation waiting period, makes the waiting animation semantically more consistent with the process of generating the target image data. By optimizing the image sequence through feature analysis and weight adjustment, the user can perceive the image generation process during the waiting period, enhancing the user's intuitive perception of the device's image data generation process and improving the user experience.

In some embodiments, another flowchart of the display method is shown in FIG. 3. As shown in FIG. 3, displaying the target image sequence in S101 can include the following.

At S301, style information corresponding to the target input data is obtained.

At S302, the display parameter corresponding to the target image sequence is adjusted according to the style information.

At S303, the target image sequence is displayed based on the adjusted display parameter.

In some embodiments, the style information may include a pre-set style type configured to assist the target intelligent engine in generating images. Specific style information may include professional style, relaxed style, and minimalist style. The present disclosure embodiment does not limit the specific style information. Display parameter may include parameter controlling the image display effect of the target image sequence. Specific display parameter may include parameter such as lighting parameter, color parameter, and detail parameter. The present disclosure embodiment does not limit the specific display parameter.

For example, the style information can be a professional style. The lighting parameter corresponding to the professional style may include that the image exhibits realistic lighting effects. The color parameter may include that the image uses realistic colors. The detail parameter may include that the image includes various realistic details. The style information can be adjusted to a minimalist style. The lighting parameter corresponding to the minimalist style can include basic light and shadow effects that differentiate between light and dark areas in the image. Color parameter can include that the image uses a single or highly contrasting color. Detail parameter can include that the image includes fewer details.

The method consistent with the present disclosure displays a target image sequence related to the input data during the image generation waiting period, making the waiting animation semantically more consistent with the process of generating the target image data. The display parameter of the image sequence is adjusted according to the style information. This satisfies users' needs for different styles, allowing users to experience the image generation process during the waiting period, enhancing the user's intuitive perception of the device's image data generation process, and improving the user experience.

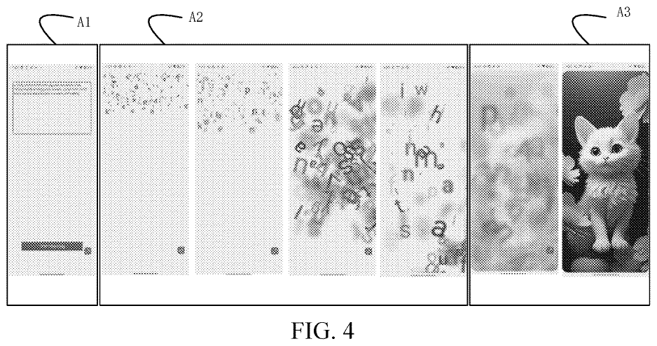

As shown in FIG. 4, the method illustrates an application scenario of the display method applied to the visual effect of generating an image from text.

At A1, text data instructing the target intelligent engine to generate target image data is input. The text data describes the target image data to be generated.

At A2, a continuous animation is displayed, the continuous animation may include each character in the input text data gradually and independently disperses, with each character moving randomly in a different direction. After reaching the edge of the screen, the characters reflect back and continue moving within the screen. Simultaneously, each character undergoes a random gradient in attributes such as size, color, blur level, and rotation angle.

At A3, if the target intelligent engine has completed the generation of the target image data, the blur level of each character continuously increases until the text disappears. Simultaneously, the target image data gradually fades from completely transparent to fully displayed, and the blur level of the target image data also changes from a high degree of blur to complete clarity.

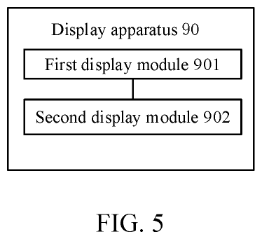

The following continues to describe an exemplary structure of the display apparatus 90 consistent with the present disclosure as a software module. In some embodiments, as shown in FIG. 5, the display apparatus 90 includes a first display module 901, configured to display a target image sequence in response to an interactive operation instructing to input the target input data into the target intelligent engine to generate image data; and a second display module 902, configured to display the target image data in response to the target intelligent engine generating the target image data, the target image sequence including at least a first image and a second image; the first image and/or the second image has a correlation with the target input data.

In some embodiments, if the target input data is first input data, the target image sequence is a first image sequence; if the target input data is second input data, the target image sequence is a second image sequence.

In some embodiments, the first image and/or the second image includes first image content and second image content; the first image content has a first correlation with the target input data, and the second image content has a second correlation with the target image data.

In some embodiments, the first image and/or the second image includes target image content representing the target input data; the target image content includes a first image parameter in the first image and a second image parameter in the second image, and the first image parameter and the second image parameter are different.

In some embodiments, the target input data includes text data; the target image content includes text data.

In some embodiments, the text data has a first degree of display disorder in the first image; the text data has a second first degree of display disorder in the second image.

In some embodiments, the first image is image data output by the target intelligent engine in a first stage; the second image is image data output by the target intelligent engine in a second stage; the target image data is the final image data output by the target intelligent engine.

In some embodiments, the display apparatus further includes an adjustment module configured to: perform feature analysis on the target input data to obtain keyword features; determine the correlation weights between the keyword features and the process by which the target intelligent engine generates target image data; and adjust the target image sequence based on the correlation weights to obtain an adjusted target image sequence.

In some embodiments, the second display module 902 can be configured to: obtain style information corresponding to the target input data; adjust the display parameter corresponding to the target image sequence according to the style information; and display the target image sequence based on the adjusted display parameter.

The description of the device in the present disclosure embodiment is similar to the description of the method embodiment above, and has similar beneficial effects as the method embodiment. Reference can be made to the descriptions in any of the accompanying drawings, FIGS. 1 to 8, for any technical details not covered in the display apparatus provided in the embodiments of the present disclosure,

The various processes shown above can be used, with rearranged, added, or deleted. For example, the processes described in the present disclosure can be executed in parallel, sequentially, or in different orders, as long as the desired result of the technical solution disclosed in the present disclosure is achieved, and this is not limited herein.

Furthermore, the terms associated with “first” and “second” are used for descriptive purposes only and should not be construed as indicating or implying relative importance or implicitly specifying the number of indicated technical features. Thus, a feature associated with “first” or “second” may explicitly or implicitly include at least one of that feature. In the description of the present disclosure, “multiple” means two or more, unless otherwise explicitly specified.

The above descriptions are merely specific embodiments of the present disclosure, but the scope of the present disclosure is not limited thereto. Any variations or substitutions that can be easily conceived by those skilled in the art within the scope of the technology disclosed in the present disclosure should be included within the scope of the present disclosure. Therefore, the scope of the present disclosure should be determined by the scope of the claims.

What is claimed is:

1. A display method comprising:
displaying a target image sequence in response to an interactive operation instructing to input target input data into a target intelligent engine for image data generation; and
displaying target image data in response to the target intelligent engine generating the target image data;
wherein:
the target image sequence includes at least a first image and a second image; and
at least one of the first image or the second image has a correlation with the target input data.

2. The method according to claim 1, wherein:
the target input data is first input data, and the target image sequence is a first image sequence; or
the target input data is second input data, and the target image sequence is a second image sequence.

3. The method according to claim 1, wherein the at least one of the first image or the second image includes at least one of first image content having a first correlation with the target input data or second image content having a second correlation with the target image data.

4. The method according to claim 1, wherein:
the at least one of the first image or the second image includes target image content representing the target input data; and
the target image content has a first image parameter in the first image and has a second image parameter in the second image, the first image parameter and the second image parameter being different.

5. The method according to claim 4, wherein:
the target input data includes text data; and
the target image content includes one or more character graphics representing the text data.

6. The method according to claim 5, wherein:
the one or more character graphics have a first degree of display disorder in the first image; and
the one or more character graphics have a second degree of display disorder in the second image.

7. The method according to claim 1, wherein:
the first image includes image data output by the target intelligent engine in a first stage;
the second image includes image data output by the target intelligent engine in a second stage; and
the target image data includes final image data output by the target intelligent engine.

8. The method according to claim 1, further comprising:
performing feature analysis on the target input data to obtain one or more keyword features;
determining one or more correlation weights each between one of the one or more keyword features and a process of the target intelligent engine generating the target image data; and
adjusting the target image sequence based on the one or more correlation weights to obtain an adjusted target image sequence.

9. The method according to claim 1, wherein displaying the target image sequence includes:
obtaining style information corresponding to the target input data;
adjusting one or more display parameters corresponding to the target image sequence according to the style information to obtain one or more adjusting display parameters; and
displaying the target image sequence based on the one or more adjusted display parameters.

10. An electronic device comprising:
a processor; and
a memory storing an application program that, when executed by the processor, causes the electronic device to:
display a target image sequence in response to an interactive operation instructing to input target input data into a target intelligent engine for image data generation; and
display target image data in response to the target intelligent engine generating the target image data;
wherein:
the target image sequence includes at least a first image and a second image; and
at least one of the first image or the second image has a correlation with the target input data.

11. The electronic device according to claim 10, wherein:
the target input data is first input data, and the target image sequence is a first image sequence; or
the target input data is second input data, and the target image sequence is a second image sequence.

12. The electronic device according to claim 10, wherein the at least one of the first image or the second image includes at least one of first image content having a first correlation with the target input data or second image content having a second correlation with the target image data.

13. The electronic device according to claim 10, wherein:
the at least one of the first image or the second image includes target image content representing the target input data; and
the target image content has a first image parameter in the first image and has a second image parameter in the second image, the first image parameter and the second image parameter being different.

14. The electronic device according to claim 13, wherein:
the target input data includes text data; and
the target image content includes one or more character graphics representing the text data.

15. The electronic device according to claim 14, wherein:
the one or more character graphics have a first degree of display disorder in the first image; and
the one or more character graphics have a second degree of display disorder in the second image.

16. The electronic device according to claim 10, wherein:
the first image includes image data output by the target intelligent engine in a first stage;
the second image includes image data output by the target intelligent engine in a second stage; and
the target image data includes final image data output by the target intelligent engine.

17. The electronic device according to claim 10, wherein the application program, when executed by the processor, further causes the electronic device to:
perform feature analysis on the target input data to obtain keyword features;
determine one or more correlation weights each between one of the one or more keyword features and a process of the target intelligent engine generating the target image data; and
adjust the target image sequence based on the correlation weights to obtain an adjusted target image sequence.

18. The electronic device according to claim 10, wherein the application program, when executed by the processor, further causes the electronic device to, when displaying the target image sequence:
obtain style information corresponding to the target input data;
adjust one or more display parameters corresponding to the target image sequence according to the style information to obtain one or more adjusting display parameters; and
display the target image sequence based on the one or more adjusted display parameters.

19. A non-transitory computer-readable storage medium storing an application program that, when executed by a processor, causes an electronic device including the processor to:
display a target image sequence in response to an interactive operation instructing to input target input data into a target intelligent engine for image data generation; and
display target image data in response to the target intelligent engine generating the target image data;
wherein:
the target image sequence includes at least a first image and a second image; and
at least one of the first image or the second image has a correlation with the target input data.

20. The non-transitory computer-readable storage medium according to claim 19, wherein:
the target input data is first input data, and the target image sequence is a first image sequence; and
the target input data is second input data, and the target image sequence is a second image sequence.
